(19) United States
(12) Patent Application Publication
(10) Pub. No.: US 2011/0274831 A1
(43) Pub. Date: Nov. 10, 2011

(54) MANUFACTURING METHOD OF ELECTRONIC PART

(75) Inventors: Kazuhiro Saegusa, Shinagawa-ku (JP); Sinya Satou, Shinagawa-ku (JP); Shogo Aizawa, Shinagawa-ku (JP)

(73) Assignee: NIPPON CHEMI-CON CORPORATION, Tokyo (JP)

(21) Appl. No.: 13/145,453

(22) PCT Filed: Feb. 15, 2010
(86) PCT No.: PCT/JP2010/000910

§ 371 Date: Jul. 20, 2011

(30) Foreign Application Priority Data
Feb. 16, 2009 (JP) 2009-033081

(51) Int. Cl. B05D 5/00; B05D 3/02; B05D 1/36

(52) U.S. Cl. 427/103; 427/126.1; 427/126.4

(57) ABSTRACT

A manufacturing method of an electronic part (varistor 2) whose device 4 is covered by an outer cover material 6, including the steps of: forming a first outer cover film 8 by coating and fixing a first outer cover film liquid material 30 that includes an organic solvent, on the device 4; and forming a second outer cover film 10 by coating and fixing a second outer cover film liquid material 34, on the first outer cover film 8. The first outer cover film includes a silicone resin or a silicone elastomer, and one or more kind (s) of aluminum hydroxide, magnesium hydrate, or calcium hydrate at a weight ratio ranging from 45/55 to 5/95.

### TECHNICAL FIELD

The present invention relates to a manufacturing method of an electronic part whose device is covered by an outer cover material and, for example, relates to a manufacturing method of an electronic part such as a voltage-dependent non-linear resistor (varistor) that is made incombustible using an incombustible material for its outer cover material.

### BACKGROUND ART

In each of various apparatuses such as an electronic apparatus or an electric apparatus, plastic is used not only for its housing but also for many of its portions and parts to reduce the weight of the apparatus and, in addition, electric parts are densely mounted to cope with the demand for downsizing of the apparatuses. With the increased uses of plastic and the dense mounting of the electronic parts, a burnout of its electronic part may cause the apparatus to combust.

A varistor is present as an electronic part that is mounted on such an apparatus. The varistor has a voltage-dependent non-linear resistance property that causes its resistance to suddenly reduce corresponding to an increase of a voltage that is applied to the varistor, and is widely used as a surge-absorbing device utilizing the property.

For a varistor: its device is formed by mixing a trace of bismuth oxide powder, etc., into zinc oxide powder, shaping this mixture into a disc using a die, thereafter, acquiring a sintered object by sintering the disc at 1,000° C. or higher, baking disc-shaped electrodes each having a diameter smaller than that of the sintered object onto both sides of the sintered object, and connecting a lead wire to the outer face of each of the electrodes by soldering; and its outer cover is formed by covering the device with an epoxy resin, etc. The outer cover has the functions of enhancing the mechanical strength of the varistor and enhancing the heat resistance thereof.

Inside the sintered object of the varistor, fine particles of zinc oxide that have small resistivity of 1 to 10 [Ω·cm] and bismuth oxide boundary layers that intervene among the fine particles of zinc oxide and that have large resistivity of 1,012 to 1,013 [Ω·cm] are present. The voltage-dependent non-linear resistance property of the varistor is acquired due to the non-ohmic property of the boundary layers and breakage finally occurs due to application of an abnormal overvoltage that exceeds the rated voltage. When this breakage occurs, the non-ohmic boundary layers of the sintered object are broken by the energy of the overvoltage and, therefore, only the resistive component can be acquired among the fine particles of zinc oxide that have the small resistivity. Therefore, the sintered object changes its property from the non-ohmic property to an ohmic property and the inside of the sintered object is short-circuited. A rush current that flows inside the sintered object generates Joule heat and, therefore, the temperature of the sintered object reaches or exceeds 1,000 [° C.] and may reach several thousand degrees centigrade depending on the case. When the sintered object is heated to a high temperature, the tin-lead solder whose melting point is 180 to 240 [° C.] melts, and the solder melted and each of the electrodes are alloyed with each other. The sintered object of the metal oxide(s) releases gases from its short-circuited portion and these gases blow out and scatter the outer cover and gush the electrodes and the solder that are alloyed.

When the epoxy resin (whose decomposition temperature is about 400 [° C.]) that is used for the outer cover is thermally decomposed, the epoxy resin releases gases such as oxygen, carbon monoxide, carbon dioxide, and carbon hydrides. The gases released may ignite due to a spark caused by a spark current that is generated in the short-circuiting.

Therefore, a flame retardant material is used for the outer cover of the varistor and an epoxy resin including, for example, bromine or antimony that is a flame retardant agent is used as the flame retardant material. A resin added with the flame retardant material that is bromine or antimony has an improved flame retardant property. However, the heating-flow rate (flowability) of the resin itself is degraded and it becomes difficult to form the outer cover film. The outer cover material can be made flame retardant when the amount of the combustible constituent in the outer cover material is reduced to the combustibility limit amount or less. However, it is known as to powder resin coating that it becomes difficult to form the outer cover film when the amount of the resin is equal to or less than 30 [wt %].

A bromine-based flame retardant agent has the function of suppressing combustion of the resin constituent due to gasification of the agent. However, the bromine constituent gasified imposes a heavy load on the environment such as destruction of the ozone layer and, therefore, use of the agent tends to be restricted.

As to the outer covering technique or the flame retarding technique, in addition to the technique of using the bromine-based flame retardant agent, Patent Document 1 discloses a varistor that uses a silicone rubber (whose decomposition temperature is about 600 [° C.]) as its coating material having an excellent flame retardant property for its protective coating.

Silicone rubber has flexibility and, therefore, even when the varistor is instantly broken due to the application of the overvoltage that exceeds the rated voltage, an effect can be expected of suppressing the scattering of the outer cover resin. A silicone paint has a flame retardant property but is not incombustible and, therefore, the silicone paint has a weak function of suppressing combustion. Silicone rubber may combust at a high temperature that causes a penetrating portion in the device.

Patent Document 2 discloses a varistor: whose outer cover material has a flame retardant property that is enhanced by adding aluminum hydroxide or magnesium hydrate as a flame retardant agent to a silicone resin or a silicone elastomer to suppress combustion of the silicone rubber; and whose silicone resin or silicone elastomer has rubber elasticity that suppresses scattering of a ceramic content and the outer cover material itself.

Patent Document 3 discloses a varistor that is covered using as an outer cover material a silicone rubber formed by adding a hardening agent to a liquid-form silicone main agent and adding aluminum hydroxide to the two agents.

### PRIOR ART DOCUMENTS

### Patent Documents

Patent Document 1: Japanese Laid-Open Patent Publication 6-215910
Patent Document 2: Japanese Laid-Open Patent Publication 2005-277100
Patent Document 3: Japanese Laid-Open Patent Publication 2006-286986

### SUMMARY OF INVENTION

### Problems to be Solved by Invention

The silicone resin or the silicon elastomer (Patent Document 2) is liquid before it is hardened and, therefore, a combustion preventive agent can be mixed and added thereto as one of the various kinds of additive agents. Therefore, the flame retardant property for the outer cover film of an electronic part, especially, a varistor is facilitated by adding thereto one kind of each of aluminum hydroxide and magnesium hydrate that each: thermally decompose when the temperature becomes high; release its water of crystallization; cause an endothermal reaction; suppress an increase of the temperature of the combustible portions; and, thereby, prevent combustion of the portions, or both of aluminum hydroxide and magnesium hydrate. However, when the amount of heat generated by the silicone resin or the silicone elastomer becomes larger than the amount of heat absorbed by the aluminum hydroxide or magnesium hydrate, the flame retardant property is degraded and, when an excessive rush current flows, the outer cover material finally combusts. Explosion proof can be secured depending on the range of the amount of aluminum hydroxide mixed (Patent Document 2). However, the range thereof within which incombustibility can be acquired is unknown and combustion may occur. When the amount of aluminum hydroxide added is increased, the explosion proof can not be secured.

A high level of safety is demanded to an electronic part such as a varistor, and a varistor having excellent safety is demanded that maintains its incombustibility and its explosion proof even when an excessive rush current flows after the varistor is broken by an overvoltage. However, conventionally, no electronic part has been proposed that satisfies such a demand.

It is difficult to substantially evenly disperse a large amount of aluminum hydroxide into a silicone elastomer and it is expected that the dispersion becomes uneven.

A first object of the present invention is to provide a manufacturing method of an electronic part whose outer cover material has secured incombustibility when the electronic part is broken and whose ceramic contents and outer cover material are prevented from scattering when the electronic part is broken.

A second object is to provide a manufacturing method of an electronic part whose silicone resin or silicone elastomer, and other agents are substantially evenly dispersed in each other.

### Means for Solving Problems

The present invention is as follows as a specific means for solving the problems.

In order to achieve the above problems, the present invention provides a manufacturing method of an electronic part whose device is covered by an outer cover material, comprising the steps of forming a first outer cover film by coating and fixing on the device a first outer cover film liquid material that includes an organic solvent; and forming a second outer cover film by coating and fixing a second outer cover film liquid material on the first outer cover film, wherein the first outer cover film includes a silicone resin or a silicone elastomer, and one or more kind (s) of aluminum hydroxide, magnesium hydrate, or calcium hydrate at a weight ratio ranging from 45/55 to 5/95.

### Effects of Invention

According to the present invention, the following effects are acquired.

(1) The first outer cover film that contacts an electronic part device and that has a secured incombustibility and the second outer cover film that has high rubber elasticity, excellent explosion proof, and excellent flame retardant property are formed and, therefore, even when the electronic part is broken due to application of an overvoltage, combustion of the outer cover material can be securely prevented and external scattering of ceramic contents and the outer cover material itself can be prevented. Therefore, even when the electronic part is broken, spread of the fire to the surrounding apparatuses, etc., can be prevented.

(2) The first outer cover film main material is substantially evenly dispersed and, thereby, incombustibility of the first outer cover film is improved.

(3) In the case where air in cavity portions of the first outer cover film is removed, when the second outer cover film is formed, the second outer cover film can be formed whose thickness is substantially even, that has no pinhole and no air bubble involved therein, that has an excellent flame retardant property, that has improved explosion proof, and whose withstand voltage is excellent.

### BRIEF DESCRIPTION OF DRAWINGS

FIG. 1 is a diagram of a varistor according to an embodiment.

FIG. 2 is a flowchart of an example of manufacturing process steps of the varistor.

FIG. 3 are diagrams of the varistor.

FIG. 4 are diagrams of an example of covering the circumference of a device with a first outer cover film.

FIG. 5 are diagrams of an example of covering the circumference of the first outer cover film with a second outer cover film.

FIG. 6 is a chart of a flaming time period property against an aluminum-hydroxide content rate.

FIG. 7 is a diagram of a varistor that is a comparative example.

### DESCRIPTION OF EMBODIMENTS

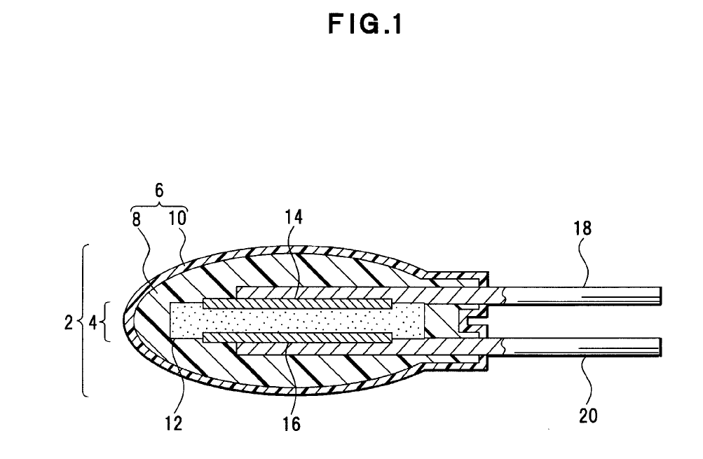

An embodiment of the present invention will be described with reference to FIG. 1. FIG. 1 is a diagram of a cross section of a varistor. The form of the varistor such as its shape depicted in FIG. 1 is an example and the present invention is not limited to this form.

This varistor 2 is an example of an electronic part such as a voltage-dependent non-linear resistor that is formed by covering a device 4 with an outer cover material 6, and includes: the device 4; and a first outer cover film 8 and a second outer cover film 10 as the outer cover material 6. The device 4 is, for example, a voltage-dependent non-linear resistor device (hereinafter, “varistor device”) and an electrode 14 is disposed on the front face of a varistor device assembly 12 and an electrode 16 is disposed on the back face thereof. The shape of the varistor device assembly 12 is, for example, a disc shape and the electrodes 14 and 16 are disposed sandwiching the varistor device assembly 12 whose front and back faces are formed in parallel to each other.

The device 4 is formed with lead terminals 18 and 20 for external connection. In the embodiment, the electrode 14 is connected to the lead terminal 18 and the electrode 16 is connected to the lead terminal 20. Therefore, an electric property such as resistance that is retained by the varistor device assembly 12 between the electrodes 14 and 16 can be acquired between the lead terminals 18 and 20.

As to the outer cover films 8 and 10 that cover the device 4, the device 4 is covered with the outer cover film 8 and the outer face of the outer cover film 8 is covered with the outer cover film 10. The device 4 is covered with the outer cover material 6 having a two-layer structure of the outer cover films 8 and 10 each having a different property from each other. The outer cover film 8 is formed by coating and fixing a first outer cover film liquid material using the first outer cover film liquid material formed by mixing a first outer cover film main material and an organic solvent into each other. The coating and fixing refers to causing a liquid material to adhere to an object by immersion or application and, thereafter, to fix on the object.

The first outer cover film main material includes a silicone resin or a silicone elastomer, and one or more kind (s) of aluminum hydroxide, magnesium hydrate, or calcium hydrate at a weight ratio ranging from 45/55 to 5/95. The first outer cover film main material is liquid before it is hardened.

For example, isopropylalcohol, etc., can be used as the organic solvent. A range of 20 to 40 parts by weight of the organic solvent is necessary when 100 parts by weight of the first outer cover film main material is used as the ratio of the organic solvent to mix it into the first outer cover film main material. When less than 20 parts by weight of the organic solvent are used, it is difficult to fully disperse aluminum hydroxide therein when aluminum hydroxide is included. When more than 40 parts by weight of the organic solvent is used, the viscosity of the first outer cover film liquid material is reduced and, thereby, the amount of the liquid material adhered to the device 4 is insufficient when the outer cover film 8 is formed. When the amount of the liquid material adhered is insufficient and, thereby, the film thickness of the outer cover film 8 becomes insufficient, the incombustibility effect is degraded. When the silicone resin or the silicone elastomer, and one or more kind (s) of aluminum hydroxide, magnesium hydrate, or calcium hydrate can be substantially evenly mixed into each other, to include no organic solvent is not prohibited. In this case, the amount of the organic solvent may range zero to 40 parts by weight.

A mixture as the first outer cover film liquid material may be used that is acquired by preparing the silicone resin or the silicone elastomer, one or more kind(s) of aluminum hydroxide, magnesium hydrate, and calcium hydrate, and the organic solvent and mixing these at a predetermined ratio, and a mixture may be used that is formed by mixing these in advance.

The outer cover film 10 only has to be an outer cover film that has excellent explosion proof and an excellent flame retardant property and, in this case, the silicone resin or the silicone elastomer, and one or more kind (s) of aluminum hydroxide, magnesium hydrate, or calcium hydrate are included therein at a weight ratio ranging from 100/0 to 50/50.

For the varistor 2, the inventor has found that the weight ratio of (A)/(B) is 45/55 or smaller with which the amount of heat absorbed by the aluminum hydroxide, magnesium hydrate, or calcium hydrate (B) becomes larger than the amount of heat generated by the silicone resin or the silicone elastomer (A) in the outer cover material 6 and, thereby, the outer cover material 6 is securely made incombustible when an excessive rush current flows between the lead terminals 18 and 20 after the varistor 2 is broken due to an overvoltage. The inventor has also found that, when the weight ratio of (A)/(B) is smaller than 5/95, it is difficult to form the outer cover film.

The inventor has also found that the one or more kind (s) of aluminum hydroxide, magnesium hydrate, or calcium hydrate can be substantially evenly dispersed into the silicone resin or the silicone elastomer by additionally mixing an organic solvent when the first outer cover film main material is mixed.

In this case, the outer cover film 10 has a high ratio of silicone and, therefore, explosion proof is secured. Aluminum hydroxide, etc., are added in the above. Therefore, the explosion proof is secured with the above range and, even when the ceramic contents reach the outer cover film 10 overcoming the outer cover film 8, none of the ceramic contents externally pops out. In addition, the flame retardant property is secured by the silicone itself and aluminum hydroxide, etc.

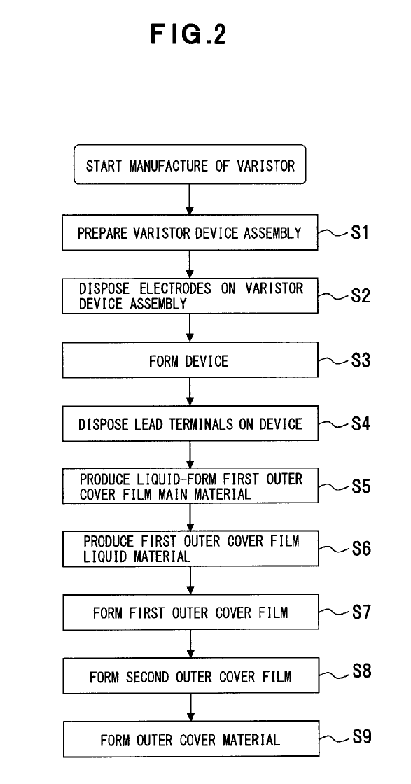

A manufacturing method of the varistor will be described. FIG. 2 is a flowchart of manufacturing process steps of the varistor. The flowchart of FIG. 2 is an example and the present invention is not limited to the manufacturing process steps.

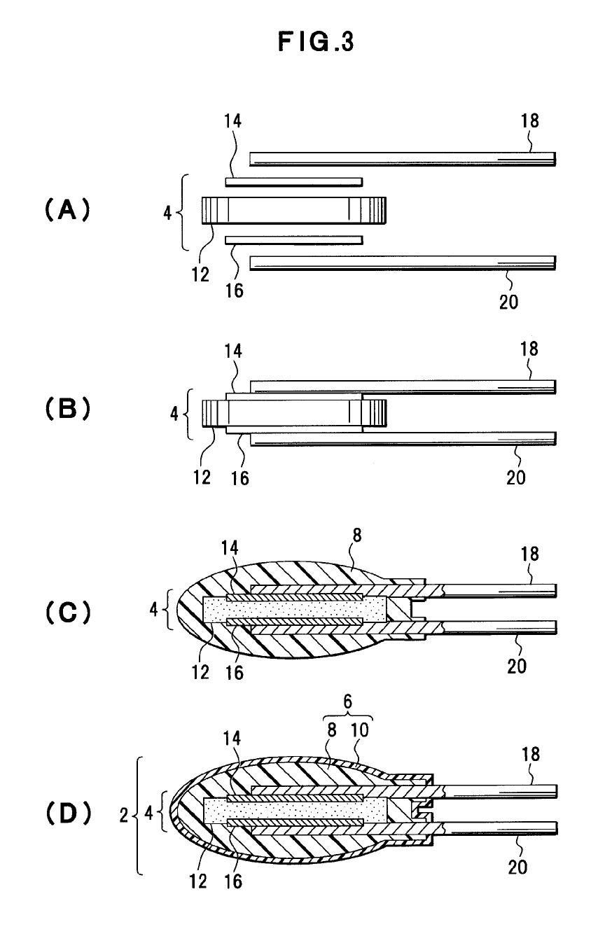

FIG. 3 are stepwise diagrams of the manufacturing process steps of the varistor: (A) is a diagram of the device and the lead terminals that are disassembled; (B) is a diagram of the device and the lead terminals that are assembled; (C) is a diagram of the first outer cover film that is formed on the circumference of the device; and (D) is a diagram of the second outer cover film that is formed on the circumference of the first outer cover film. In FIG. 3, to simplify the description, constituents that are same as those of FIG. 1 are given the same reference numerals.

In the varistor, for example, a ceramic device assembly configured by a sintered object that includes zinc oxide as its main constituent, that includes magnesium oxide, bismuth oxide, cobalt oxide, etc., added thereto, and that is formed into a disc is used as the varistor device assembly 12.

When the manufacture of the varistor is started: the varistor device assembly 12 is prepared (step S1); the electrode 14 is printed on the front face of the varistor device assembly 12 and the electrode 16 is printed on the back face thereof and, thereafter, the electrodes 14 and 16 are respectively disposed on the front and the back faces of the varistor device assembly 12 by sintering (step S2); and, the device 4 is formed (step S3).

The lead terminal 18 is connected to the electrode 14 and the lead terminal 20 is connected to the electrode 16 by soldering, etc., and the lead terminals 18 and 20 are disposed on the device 4 (step S4). As depicted in FIG. 3(B), the device 4 is formed that is provided with the lead terminals 18 and 20.

The silicone resin or the silicone elastomer, and one or more kind(s) of aluminum hydroxide, magnesium hydrate, or calcium hydrate are caused to be included in each other at a weight ratio ranging from 45/55 to 5/95 and, thereby, the first outer cover film main material is produced (step S5). The first outer cover film main material is liquid.

The organic solvent is mixed into the first outer cover film main material and, thereby, the first outer cover film liquid material is produced (step S6). Isopropylalcohol, etc., are used as the organic solvent. The range of 20 to 40 parts by weight of the organic solvent is caused to be included when 100 parts by weight of the first outer cover film main material is used.

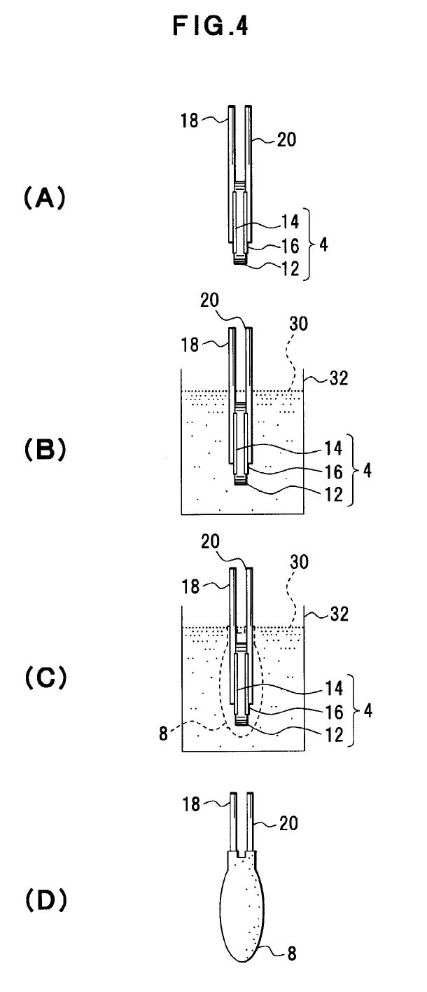

FIG. 4 are diagrams of an example of process steps of covering the circumference of the device with the first outer cover film: (A) is a diagram of the device that is provided with the lead terminals; (B) and (C) are diagrams of the device that is immersed in the first outer cover film liquid material; and (D) is a diagram of the device that is lifted up therefrom.

As depicted in FIG. 4, for example, when the device 4 that is provided with the lead terminals 18 and 20 is held with the lead terminals 18 and 20 thereabove (A) and the device 4 is immersed in a liquid material containing unit 32 that accommodates a first outer cover film liquid material 30 (B), the outer cover film liquid material 30 adheres the circumference of the device 4 (C) and, when the device 4 is lifted up therefrom in this state, the device 4 having the outer cover film liquid material 30 (8) adhering on its circumference is acquired (D).

The outer cover film liquid material 30 is a liquid that has viscosity and, therefore, when the device 4 is left alone being lifted up therefrom, the outer cover film liquid material 30 trickles down toward the lower portion of the device 4 until the outer cover film liquid material 30 dries and hardens. As a result, the coating thickness in the lower portion becomes thick. This coating thickness can be adjusted using the time period, the ambient temperature, the manner of heating, etc.

As above: the device 4 is immersed in the outer cover film liquid material 30; is lifted up therefrom; thereafter, is hardened by heating the device 4 at 100 [° C.] for 30 [min]; thereby, the outer cover film liquid material 30 is coated on and fixed to the circumference of the device 4; and, thereby, the outer cover film 8 is formed (step S7). The method of forming the outer cover film 8 on the circumference of the device 4 is not limited to the above. For example, the outer cover film liquid material 30 may be applied to the device 4 or the outer cover film liquid material 30 may be coated and fixed by being dried and hardened by being left alone or being air-blown instead of the hardening by heating.

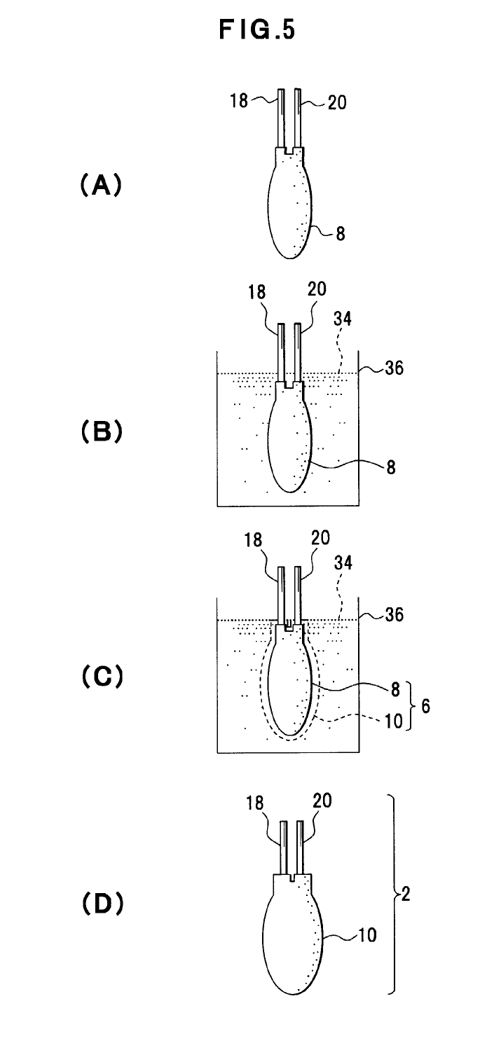

The outer cover film 10 is formed (step S8). FIG. 5 are diagrams of an example of process steps of covering the circumference of the first outer cover film with a second outer cover film: (A) is a diagram of the state where the first outer cover film is formed on the circumference of the device; (B) and (C) are diagrams of the first outer cover film that is immersed in the second outer cover film liquid material; and (D) is a diagram of the device that is lifted up after the immersion.

As depicted in FIG. 5, for example, when the device 4 that is provided with the lead terminals 18 and 20 and that is formed with the outer cover film 8 on its circumference is held with the lead terminals 18 and 20 thereabove (A) and is immersed in a liquid material containing unit 36 that accommodates a second outer cover film liquid material 34 (B), the outer cover film liquid material 34 adheres the circumference of the outer cover film 8 (C) and when the device 4 is lifted up in this state, the varistor 2 is acquired that has the outer cover film liquid material 34 adhering to the circumference of the outer cover film 8 and that has the outer cover material 6 configured by the outer cover film 8 and the outer cover film 10, formed on the circumference of the device 4 (D).

In the forming of the outer cover film 10, for example, a method, etc., may be used of: immersing the device 4 formed with the outer cover film 8 in the outer cover film liquid material 34; lifting up the device 4 therefrom; thereafter, hardening by heating the device 4 at 100 [° C.] for 30 [min]; thereby, the outer cover film liquid material 34 is coated and fixed on the circumference of the outer cover film 8; and, thereby, the outer cover film 10 is formed. In this manner, the outer cover material 6 can be formed that covers the device 4 with two layers of films that are the outer cover films 8 and 10 (step S9).

For example, the outer cover film 10 only has to be a film having explosion proof such as a raw material having high rubber elasticity and, preferably, the outer cover film liquid material 34 may be used that includes, for example, a silicone resin or a silicone elastomer, and one or more kind (s) of aluminum hydroxide, magnesium hydrate, or calcium hydrate at a weight ratio ranging from 100/0 to 50/50.

As to the outer cover film 10: when the outer cover film 8 is immersed in the outer cover film liquid material 34, the immersion may be executed in reduced-pressure ambient atmosphere and, when the outer cover film 8 is lifted up from the outer cover film liquid material 34, the reduced-pressure ambient atmosphere is released and, thereafter, the outer cover film liquid material 34 may be hardened by heating. In the case where the outer cover film 8 is formed, because the organic solvent is mixed into the outer cover film liquid material 30, cavities may be formed when the organic solvent evaporates. However, by immersing the outer cover film 8 in the outer cover film liquid material 34 in the reduced-pressure ambient atmosphere, lifting up the outer cover film 8 from the outer cover film liquid material 34 with the reduced-pressure ambient atmosphere released, and, thereafter, hardening the outer cover film liquid material 34 by heating as above, the outer cover film 10 can be formed with the air removed from the cavity portions formed in the outer cover film 8. Therefore, the outer cover film 10 can be formed whose thickness is substantially even, that has no pinhole and air bubble involved therein, that has an excellent flame retardant property, that has improved explosion proof, and whose withstand voltage is excellent.

Preferably, the pressure may be 5 [kPa] or lower of the reduced-pressure ambient atmosphere that is used when the outer cover film 8 is immersed in the outer cover film liquid material 34. This is because the removal of the air in the cavity portions of the outer cover film 8 may not be fully executed when the pressure of the reduced-pressure ambient atmosphere exceeds 5 [kPa]. This is also because, when any air remains in the cavity portions of the outer cover film 8, the thickness of the outer cover film 10 may become uneven, pinholes may be generated and air bubbles may be involved, and the withstand voltage and the explosion proof may not sufficiently be secured. The outer cover film 8 does not need to be immersed in the outer cover film liquid material 34 in the reduced-pressure ambient atmosphere in the cases where no organic solvent is included in the first outer cover film main material, where the outer cover film 8 is formed to have no cavity portions generated therein, etc.

The release of the reduced-pressure ambient atmosphere for lifting up the outer cover film 8 after its immersion in the outer cover film liquid material 34 only has to be a pressure that is higher than that of the reduced-pressure ambient atmosphere used for the immersion of the outer cover film 8 and, for example, the lifting up may be executed in the ordinary-pressure ambient atmosphere or pressured ambient atmosphere.

The method of forming the outer cover film 10 on the circumference of the outer cover film 8 is not limited to the above and, for example, the outer cover film liquid material 34 may be applied to the outer cover film 8 or the outer cover film liquid material 30 may be coated and fixed by being dried and hardened by being left alone or being air-blown instead of the hardening by heating.

### Other Embodiments

Though the varistor is exemplified as the electronic part in the above embodiment, the electronic part that is formed by covering a device with an outer cover material may be an electronic part other than the varistor and the device may be a device such as a transistor or a diode.

### EXAMPLES

### First Example

A first example of the varistor of the present invention will be described. To configure the varistor 2 that has a structure depicted in FIG. 1, a ceramic device assembly is used as the varistor device assembly 12 of the device 4. For the varistor device assembly 12 formed by the ceramic device assembly, for example, a varistor device assembly is used: that is formed by printing and sintering the electrodes 14 and 16 each having the diameter of 8 [mm] on both sides of a sintered object that has the diameter of 10 [mm] and that includes zinc oxide as its main constituent added with magnesium oxide, bismuth oxide, cobalt oxide, etc.; and that has the lead terminals 18 and 20 soldered on the surface of each of the electrodes 14 and 16.

The organic solvent is mixed into the liquid-form first outer cover film main material that is for configuring the outer cover film 8 and, thereby, the outer cover film liquid material 30 is acquired. The varistor device assembly 12 having the lead terminals 18 and 20 soldered thereto: is dipped in the outer cover film liquid material 30; is lifted up therefrom; and, thereafter, is hardened by heating the varistor device assembly 12 at 100 [° C.] for 30 [min]. Thereby, the outer cover film liquid material 30 is coated and fixed on the circumference of the device 4 and, thereby, the outer cover film 8 is formed. Preferably, when the outer cover film liquid material 30 is coated and fixed, the outer cover film liquid material 30 may be hardened by heating it. However, the hardening and the fixation may also be executed by, for example, drying by leaving the material alone or drying by air-blowing.

The device 4 formed with the outer cover film 8: is dipped in the outer cover film liquid material 34 that is for configuring the outer cover film 10; is lifted up therefrom; and is hardened by heating the device 4 at 100 [° C.] for 30 [min]. Thereby, the outer cover film 10 is formed.

The silicone elastomer as the first outer cover material is a two-liquid addition reaction rubber and the rubber elasticity thereof is acquired by mixing the liquid-form rubber main body and a hardening agent into each other and hardening the mixture by heating it.

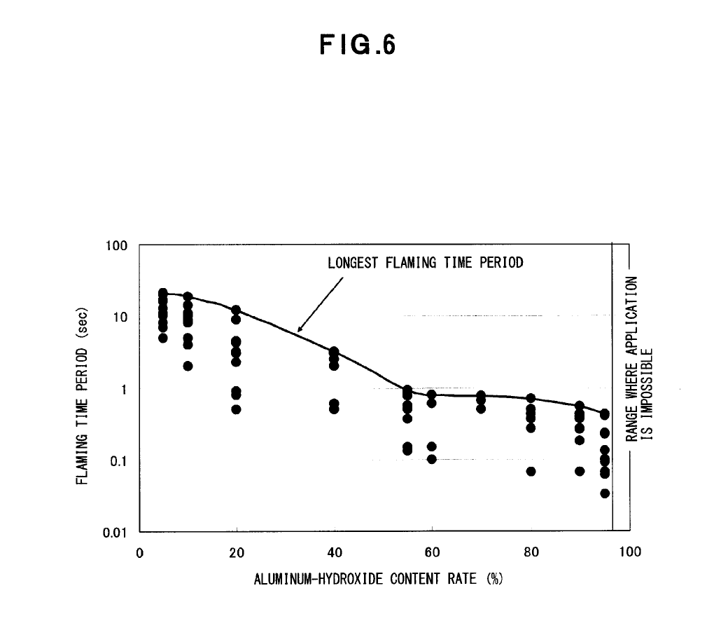

Table 1 presents data of FIG. 6 and the data in the table indicates the combustion continuing time period. The data indicates an example of applying to the device 4 the outer cover material including the silicone elastomer and aluminum hydroxide at a ratio varied between 95:5 and 5:95. After this application, the mixture is hardened by heating the mixture and, thereby, the first outer cover film is formed.

TABLE 1

| ALUMINUM- | | | | | | | | | | | |
|---|---|---|---|---|---|---|---|---|---|---|---|
| HYDROXIDE | | | | | | | | | | | |
| CONTENT RATE | | | | | | | | | | | |
| [%] | No 1 | No 2 | No 3 | No 4 | No 5 | No 6 | No 7 | No 8 | No 9 | No 10 | Max |
| 5 | 10 | 13 | 20 | 11 | 16 | 8 | 5 | 7 | 17 | 21 | 21 |
| 10 | 14 | 8 | 5 | 19 | 10 | 11 | 9 | 8 | 4 | 2 | 19 |
| 20 | 12 | 0.9 | 0.8 | 0.5 | 9 | 3 | 4.5 | 2.3 | 4.2 | 3.2 | 12 |
| 40 | 2.5 | 3 | 2 | 0.5 | 0.6 | 3.2 | | | | | 3.2 |
| 55 | 0.92 | 0.5 | 0.13 | 0.88 | 0.36 | 0.15 | 0.76 | 0.56 | 0.86 | 0.93 | 0.93 |
| 60 | 0.8 | 0.6 | 0.099 | 0.15 | | | | | | | 0.8 |
| 70 | 0.5 | 0.66 | 0.77 | | | | | | | | 0.77 |
| 80 | 0.5 | 0.43 | | 0.36 | 0.266 | 0.066 | 0.69 | | | | 0.69 |
| 90 | 0.42 | 0.36 | 0.066 | 0.26 | 0.18 | 0.39 | 0.54 | 0.36 | 0.27 | 0.43 | 0.54 |
| 95 | 0.09 | 0.13 | 0.42 | 0.033 | 0.066 | 0.06 | 0.1 | 0.22 | 0.23 | 0.4 | 0.42 |

The second outer cover material is formed by applying a mixture including the silicone elastomer and aluminum hydroxide at a ratio of the silicone elastomer:aluminum hydroxide=80:20 and, thereafter, hardening the mixture by heating it.

The ratio of aluminum hydroxide added in this case is the ratio by the weight of aluminum hydroxide to the total weight of the liquid-form silicone main agent and the hardening agent.

An overvoltage test was conducted by applying an AC voltage such that the voltage application rate (varistor voltage V1 mA/AC effective voltage) was equal to 0.87. After the varistor device has been broken, an AC current of 40 [A] flows when the varistor device is short-circuited, and a rush current flows until a 7-A fuse is blown. The temperature of the device is increased due to the rush current flowing during this time period, and the outer cover is influenced. FIG. 6 is a chart of the result of a check on the continued flaming time period of the outer cover film 10 after the rush current is applied.

In the range of the present invention, flaming occurs at the moment when the temperature of the device 4 reaches in the vicinity of 1,000 [° C.]. However, the heat is instantly absorbed and the flaming is extinguished. In contrast, when the amount of aluminum hydroxide is small, the flaming continues. No scattering occurs of both of the ceramic contents and the outer cover film 8 from the varistor device assembly 12 and, thereby, it can be seen that the explosion proof is secured by the outer cover film 10.

The result of the experiment depicted in FIG. 6 is the result of application of an AC voltage that is AC: 527 [V] (effective voltage) using a power source: 40 [A] max, a serial resistor: 5 [Ω], and a fuse 7-A that is serially inserted, to a varistor that is formed by applying the first outer cover film: 0.20 [g] and applying the second outer cover film: 0.35 [g] (the silicone elastomer:aluminum hydroxide=80:20) to the varistor device of 10φ and 620 [V]. In this case, the time period until the fuse is blown, the circuit is open, and the flaming is extinguished is evaluated.

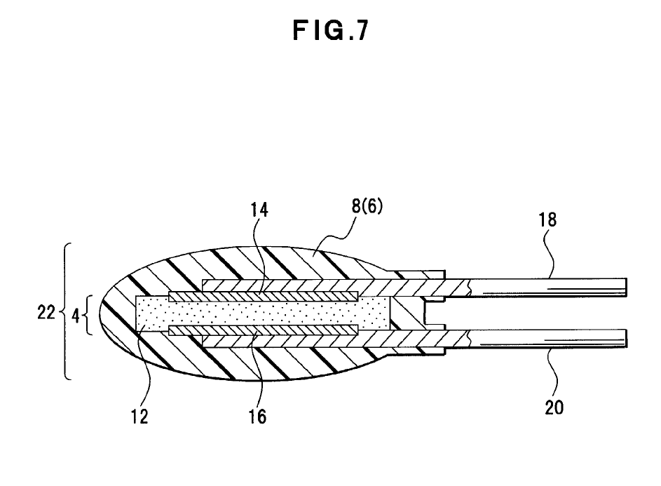

As a comparative example, FIG. 7 depicts a varistor that includes no outer cover film 10 (FIG. 1). The varistor 22 is same as the varistor 2 (FIG. 1) except that the varistor 22 includes no outer cover film 10 and, therefore, the same reference numerals are given. In the range for continuous combustion of the example (the case where the amount of aluminum hydroxide is small), the similar continuous combustion occurs and no scattering occurs. In the range for non-continuous combustion, scattering is observed. This scattering becomes more remarkable as the amount of aluminum hydroxide becomes larger. In this range, for the 45/55 pattern, etc., with relatively few cases of scattering, no continuous combustion occurs to the samples with no scattering.

### Second Example

In the first example, the case where aluminum hydroxide is added to the silicone elastomer has been described. However, in a second example, the same result was also acquired when the silicone resin was used instead of the silicone elastomer and when magnesium hydrate or calcium hydrate was used instead of aluminum hydroxide. Aluminum hydroxide is mainly used as the flame retardant agent, and magnesium hydrate and calcium hydrate each present the flame retardant property based on the same mechanism as that of aluminum hydroxide.

### Third Example

In the first example, the outer cover film 10 is formed in the ordinary-pressure ambient atmosphere. However, in a third example, the outer cover film 8: is immersed in the outer cover film liquid material 34 in reduced-pressure ambient atmosphere whose pressure is 2 [kPa]; and is lifted up from the outer cover film liquid material 34 in the ordinary-pressure ambient atmosphere, and, thereby, the outer cover film 10 is formed. The ordinary-pressure ambient atmosphere is an example of the state where the condition of the reduced-pressure ambient atmosphere is cancelled, and the state of the ambient atmosphere is not limit to this.

The device 4 having the lead terminals 18 and 20 soldered thereto: is dipped in the outer cover film liquid material 30 having the organic solvent mixed thereinto; is lifted up therefrom; and, thereafter, is hardened by heating the device 4 at 100 [° C.] for 30 [min]. Thereby, the outer cover film liquid material 30 is coated and fixed on the circumference of the device 4 and, thereby, the outer cover film 8 is formed.

The surroundings are set to be the reduced-pressure ambient atmosphere whose pressure is 2 [kPa] and the device 4 formed with the outer cover film 8 is dipped in the outer cover film liquid material 34. The reduced-pressure ambient atmosphere is returned to the ordinary-pressured ambient atmosphere, and the device 4 is lifted up therefrom under this condition and hardened by heating at 100 [° C.] for 30 [min]. Thereby, the outer cover film 10 is formed.

Table 2 presents the result of a test on the withstand voltage of the outer cover material 6 of each of a varistor (reduced-pressure application) that is acquired in the third example and a varistor (ordinary-pressure application) whose outer cover film 10 is formed in the ordinary-pressure ambient atmosphere.

The withstand voltage test on the outer cover material 6 is a test that is executed by: simultaneously clamping the lead terminals 18 and 20 of the varistor; using the lead terminals 18 and 20 as one pole; using a lead ball as the other pole that is brought into contact with the outer surface of the outer cover material 6; applying a potential of 2.5 [kV] between these poles for 60 [sec]; and checking whether short-circuiting occurs between the poles.

TABLE 2

| | | NUMBER OF WITHSTAND | NUMBER OF IMPROPER | |
|---|---|---|---|---|
| WAY OF | | VOLTAGE TESTS | WITHSTAND VOLTAGES | IMPROPER WITHSTAND |
| APPLICATION | Lot. | (VARISTORS) | (VARISTORS) | VOLTAGE RATE (%) |
| ORDINARY- | 1 | 432 | 117 | 27.1 |
| PRESSURE | 2 | 432 | 42 | 9.7 |
| APPLICATION | | | | |
| REDUCED- | 3 | 216 | 0 | 0.0 |
| PRESSURE | 4 | 216 | 0 | 0.0 |
| APPLICATION | 5 | 432 | 0 | 0.0 |
| | 6 | 360 | 0 | 0.0 |

From the result presented in Table 2, occurrence of any improper withstand voltage to the outer cover material 6 can be prevented when the outer cover film 10 is formed by: immersing the device 4 having the outer cover film 8 that is formed in the reduced-pressure ambient atmosphere, in the outer cover film liquid 34; and lifting up from the outer cover film liquid material 34 in the ordinary-pressure ambient atmosphere.

As above, according to the third example, occurrence of any improper withstand voltage can be prevented. However, the formation of the outer cover film 8 is not limited to this and the outer cover film 8 only able to be formed not to cause any cavity portion to be formed.

As above, most preferred embodiment, etc., of the present invention have been described. However, the present invention is not limited to the above, and those skilled in the art can make various modifications and changes to the present invention based on the purview of the present invention that is described in claims or that is disclosed in “Description of Embodiments”. Needless to say, such modifications and changes are included in the scope of the present invention.

### INDUSTRIAL APPLICABILITY

The present invention is widely usable for electronic parts such as a varistor, and is useful.

### EXPLANATIONS OF LETTERS OR NUMERALS

2 varistor
4 device
6 outer cover material
8 first outer cover film
10 second outer cover film
12 varistor device assembly
30 first outer cover film liquid material
34 second outer cover film liquid material

1. A manufacturing method of an electronic part whose device is covered by an outer cover material, comprising the steps of:
forming a first outer cover film by coating and fixing on the device a first outer cover film liquid material that includes an organic solvent; and
forming a second outer cover film by coating and fixing a second outer cover film liquid material on the first outer cover film, wherein
the first outer cover film includes a silicone resin or a silicone elastomer, and one or more kind(s) of aluminum hydroxide, magnesium hydrate, or calcium hydrate at a weight ratio ranging from 45/55 to 5/95.

2. The manufacturing method of an electronic part of claim 1, wherein the second outer cover film is formed by coating and fixing the second outer cover film liquid material on the first outer cover film in reduced-pressure ambient atmosphere, thereafter, releasing the reduced-pressure ambient atmosphere, and hardening by heating.

3. The manufacturing method of an electronic part of claim 1, wherein the second outer cover film includes a silicone resin or a silicone elastomer, and one or more kind(s) of aluminum hydroxide, magnesium hydrate, or calcium hydrate at a weight ratio ranging from 100/0 to 50/50.

4. The manufacturing method of an electronic part of claim 1, wherein a weight ratio of the organic solvent ranges from 20 to 40 parts by weight to 100 parts by weight of a main material of the first outer cover film.

5. The manufacturing method of an electronic part of claim 1, wherein the organic solvent is isopropylalcohol.

6. The manufacturing method of an electronic part of claim 2, wherein a pressure of the reduced-pressure ambient atmosphere is 5 kPa or lower.

7. The manufacturing method of an electronic part of claim 1, wherein the device is a voltage-dependent non-linear resistor device.

8. The manufacturing method of an electronic part of claim 2, wherein the second outer cover film includes a silicone resin or a silicone elastomer, and one or more kind(s) of aluminum hydroxide, magnesium hydrate, or calcium hydrate at a weight ratio ranging from 100/0 to 50/50.

9. The manufacturing method of an electronic part of claim 4, wherein the organic solvent is isopropylalcohol.
